(19) United States
(12) Patent Application Publication
(10) Pub. No.: US 2008/0320099 A1
(43) Pub. Date: Dec. 25, 2008

(54) CONNECTOR AND COMMUNICATION METHOD THEREOF

(75) Inventors: Duk-hoon Bahn, Seoul (KR); Jung-yon Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/949,271

(22) Filed: Dec. 3, 2007

(30) Foreign Application Priority Data
Jun. 19, 2007 (KR) 10-2007-0059963

(51) Int. Cl. G06F 15/16

(52) U.S. Cl. 709/217

(57) ABSTRACT

A connector includes: a cable connecting unit that is connected with a cable via which a signal is transmitted from a first network apparatus; an apparatus connecting unit that is connected with a second network apparatus; a communicating unit that communicates with the first network apparatus and the second network apparatus; and a controller that controls the communicating unit to deliver the signal, which is received from the first network apparatus via the cable connecting unit, to the second network apparatus if the first network apparatus is a preset apparatus.

### CROSS-REFERENCE TO RELATED APPLICATIONS

This application claims priority from Korean Patent Application No. 10-2007-0059963, filed on Jun. 19, 2007 in the Korean Intellectual Property Office, the disclosure of which is incorporated herein by reference.

### BACKGROUND OF INVENTION

1. Field of Invention

Apparatuses and methods consistent with the present invention relate to a connector and a communication method thereof, and more particularly, to a connector which is capable of being connected to apparatuses forming a network, and a communication method thereof.

2. Description of the Related Art

A connector such as RJ-45 is connected to a local area network (LAN) card or a hub to allow data exchange between network apparatuses. Examples of network apparatuses may include a computer, a printer, a TV, and other network devices known in the art, in which a relay such as a hub, a modem or the like and a network device such as a LAN card are installed. An example of a network system is a Transmission Control Protocol/Internet Protocol (TCP/IP) Ethernet system in which apparatuses included in a network form a sub-network.

However, apparatuses which belong to the same sub-network may have weak security. For example, in a home having a home network, it is not difficult to access apparatuses forming the home network from outside the network. Particularly, in an apartment in which a plurality of homes forms the same sub-network, access may be made from an apparatus of a home to an apparatus of another home. In addition, in an office, access may be made between apparatuses in different departments, the apparatuses forming the same sub-network.

There is a need to individually establish security of apparatuses forming a network or setup a different sub-network to form a network among only particular apparatuses.

In particular, some apparatuses which belong to a sub-network may form a particular network, separately from other apparatuses of the same sub-network, for security or according to a user's need. For example, the particular network may include apparatuses which belong to each home in an apartment, or include apparatuses which belong to each department in an office.

However, a user has to know a complicated access control method in order to set security of an apparatus. That is, there arises a problem in that it is too complicated for the user to set security to allow access from only particular apparatuses which belong to a network. For example, the user needs to know the Internet Protocol (IP) address or media access control (MAC) address and has difficulty adding to, deleting from, modifying, etc an access control list.

### SUMMARY OF THE INVENTION

Accordingly, it is an aspect of the present invention to provide a connector and a communication method thereof, which make it possible to form a network of only apparatuses, which are desired by a user, among a plurality of network apparatuses, by a method convenient to the user.

Additional aspects of the present invention will be set forth in part in the description which follows and, in part, will be obvious from the description, or may be learned by practice of the present invention.

The foregoing and/or other aspects of the present invention can be achieved by providing a connector including: a cable connecting unit that is connected with a cable via which a signal is transmitted from a first network apparatus; an apparatus connecting unit that is connected with a second network apparatus; a communicating unit that communicates with the first network apparatus and the second network apparatus; and a controller that controls the communicating unit to deliver the signal, which is received from the first network apparatus via the cable connecting unit, to the second network apparatus if the first network apparatus is a preset apparatus.

According to an aspect of the invention, if a network ID of the first network apparatus is a preset network ID, the controller determines the first network apparatus to be the preset apparatus.

According to an aspect of the invention, the connector further includes an identification (ID) input unit that receives the preset network ID from a user.

According to an aspect of the invention, the preset network ID is binary data of a plurality of bits.

According to an aspect of the invention, the ID input unit includes a switching unit that sets each bit of the plurality of bits.

According to an aspect of the invention, the controller confirms a media access control (MAC) address of the first network apparatus for the signal transmitted from the first network apparatus having the preset network ID, and, if the MAC address is a preset MAC address, the controller determines the first network apparatus to be the preset apparatus.

According to an aspect of the invention, the connector further includes a storing unit in which a plurality of MAC addresses are stored, wherein the controller stores the MAC address of the first network apparatus having the preset network ID in the storing unit.

According to an aspect of the invention, the controller deletes the MAC address of the first network apparatus that transmits the signal, based on information of the signal received via the cable connecting unit.

According to an aspect of the invention, the controller controls the communicating unit to deliver the signal to the second network apparatus based on a media access control (MAC) address of the preset apparatus.

According to an aspect of the invention, the connector further includes a function selecting unit that receives an ON/OFF selection signal from a user, wherein the controller controls the communicating unit to deliver the signal, which is transmitted from the preset apparatus, to the second network apparatus according to the ON/OFF selection signal through the function selecting unit.

According to an aspect of the invention, the connector has a form of a dongle.

The foregoing and/or other aspects of the present invention can be achieved by providing a connector including: an apparatus connecting unit that is connected with a first network apparatus; a cable connecting unit that is connected with a cable via which a signal is transmitted from a second network apparatus; a communicating unit that communicates with the first network apparatus and the second network apparatus; and a controller that controls the communicating unit to deliver a preset network ID to the second network apparatus.

According to an aspect of the invention, the connector further includes an ID input unit that receives the preset network ID from a user.

According to an aspect of the invention, the preset network ID is binary data of a plurality of bits.

According to an aspect of the invention, the ID input unit includes a switching unit that sets each bit of the plurality of bits.

According to an aspect of the invention, the connector further includes a function selecting unit that receives an ON/OFF selection signal from a user, wherein the controller controls the communicating unit to deliver the preset network ID to the second network apparatus according to the ON/OFF selection signal through the function selecting unit.

The foregoing and/or other aspects of the present invention can be achieved by providing a communication method of a connector, including: receiving a signal from a first network apparatus; determining whether the first network apparatus that transmits the signal is a preset apparatus; and delivering the signal to a second network apparatus if the first network apparatus is the preset apparatus.

According to an aspect of the invention, the determining whether the first network apparatus that transmits the signal is a preset apparatus includes determining the first network apparatus to be the preset apparatus if a network ID of the first network apparatus is a preset network ID.

According to an aspect of the invention, the communication method further includes receiving the preset network ID from a user.

According to an aspect of the invention, the preset network ID is binary data of a plurality of bits.

According to an aspect of the invention, the determining whether the first network apparatus that transmits the signal is a preset apparatus includes confirming a media access control (MAC) address of the first network apparatus for the signal transmitted from the first network apparatus having the preset network ID and determining the first network apparatus to be the preset apparatus if the MAC address is a preset MAC address.

According to an aspect of the invention, the communication method further includes storing the MAC address of the first network apparatus having the preset network ID.

According to an aspect of the invention, the communication method further includes deleting the MAC address of the first network apparatus that transmits the signal based on information of the received signal.

According to an aspect of the invention, the delivering the signal to the second network apparatus includes delivering the signal to the second network apparatus based on a media access control (MAC) address of the preset apparatus.

The foregoing and/or other aspects of the present invention can be achieved by providing a communication method of a connector, including: receiving a signal from a first network apparatus; and adding a preset network ID in the signal and delivering the signal to a second network apparatus.

According to an aspect of the invention, the communication method further includes receiving the preset network ID from a user.

According to an aspect of the invention, the preset network ID is binary data of a plurality of bits.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram showing a configuration of a connector according to an exemplary embodiment of the present invention;

FIG. 2 is a block diagram showing a configuration of a connector according to another exemplary embodiment of the present invention;

FIG. 3 is a block diagram showing a configuration of two connectors according to an exemplary embodiment of the present invention;

FIG. 4 is a diagram showing a network configuration according to an exemplary embodiment of the present invention;

FIG. 5A is a view showing an external appearance of a connector according to an exemplary embodiment of the present invention;

FIG. 5B is a view showing an external appearance of a connector according to another exemplary embodiment of the present invention;

FIG. 6 is a flow chart illustrating an operation of a connector according to an exemplary embodiment of the present invention; and

FIG. 7 is a flow chart illustrating an operation of a connector according to another exemplary embodiment of the present invention.

### DETAILED DESCRIPTION OF EXEMPLARY EMBODIMENTS OF THE INVENTION

Reference will now be made in detail to embodiments of the present invention, examples of which are illustrated in the accompanying drawings, wherein like reference numerals refer to like elements throughout. The exemplary embodiments are described below so as to explain the present invention by referring to the figures.

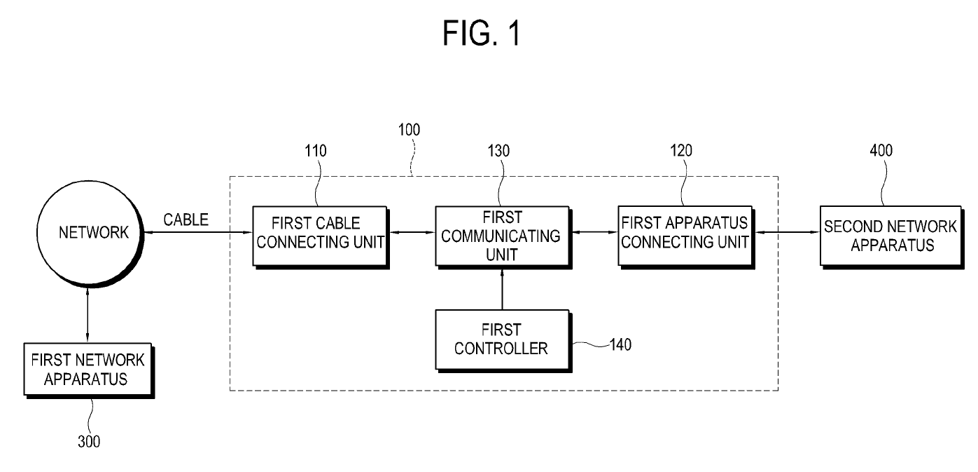

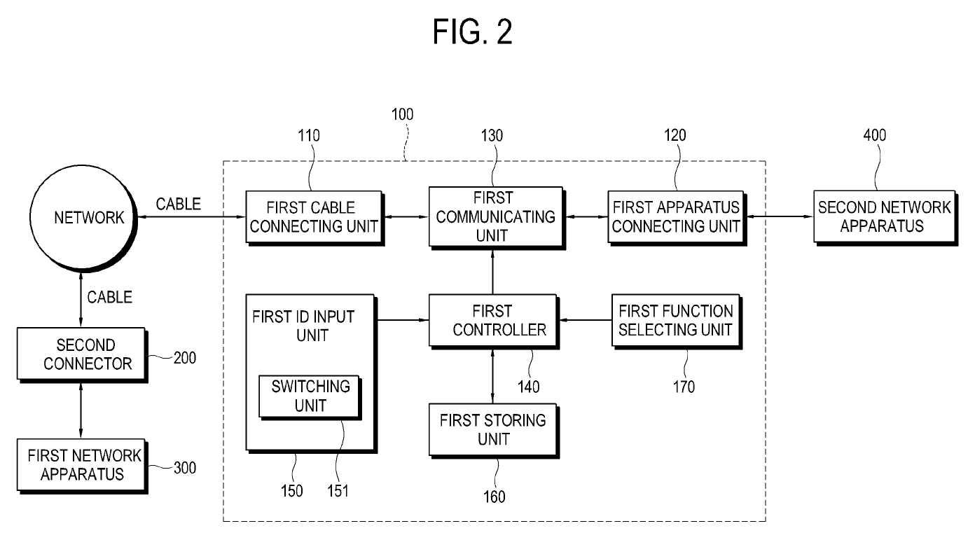

FIG. 1 is a block diagram showing a configuration of a connector according to an exemplary embodiment of the present invention, and FIG. 2 is a block diagram showing a configuration of a connector according to another exemplary embodiment of the present invention. A connector according to an exemplary embodiment of the present invention is connected to a network device of a network apparatus and transmits a signal, which is received from a different network apparatus, to the network apparatus to which the connector is connected. For example, the connector includes one end coupled to a LAN card of a computer and the other end coupled to an RJ-45 plug to which an unshielded twisted pair (UTP) cable is connected, and it is determined based on preset information whether to pass or intercept signals that are transmitted/received through both ends of the connector.

In the following description, for the sake of convenience, it is assumed that the connector is differentiated into a first connector 100 connected to a second network apparatus 400 and a second connector 200 connected to a first network apparatus 300 although the first and second connectors have the same configuration.

As shown in FIG. 1, the first connector 100 includes a first cable connecting unit 110, a first apparatus connecting unit 120, a first communicating unit 130 and a first controller 140.

The first cable connecting unit 110 is connected with a cable via which a signal is transmitted from the first network apparatus 300. Specifically, the first cable connecting unit 110 is connected to a plug of the cable that connects a network to the first cable connecting unit 110. For example, the first cable connecting unit 110 may be connected with an RJ-45 plug of a UTP cable.

The first apparatus connecting unit 120 is connected to the second network apparatus 400. Specifically, the first apparatus connecting unit 120 is connected to a network device of the second network apparatus 400. For example, the first apparatus connecting unit 120 may be connected to an RJ-45 port of a LAN card.

The first communicating unit 130 communicates with the first and second network apparatuses 300 and 400. The first communicating unit 130 delivers or intercepts the signal, which is received from the first network apparatus 300, to the second network apparatus 400 under control of the first controller 140. In addition, the first communicating unit 130 may generate a new signal or combine signals under control of the first controller 140.

If the first network apparatus 300 that transmits the signal received via the first cable connecting unit 110 is a preset apparatus, the first controller 140 controls the first communicating unit 130 to deliver the signal to the second network apparatus 400. The signal may include all signals for communication in a network of a TCP/IP Ethernet system. The signal also includes identification information of the first network apparatus 300. The identification information includes a MAC address, an IP address and so on. In addition, the signal may include a network identification (ID) for network setting. Accordingly, the first controller 140 may discriminate an apparatus, which transmits the signal, among a plurality of apparatuses connected to the network based on the identification information included in the signal. For example, if the identification information of the apparatus that transmits the signal is identification information of apparatuses having the same network ID, the first controller 140 passes the signal, which is received via the first cable connecting unit 110, to the first apparatus connecting unit 120, and, if the identification information is not the pre-stored information, controls the first communicating unit 130 to intercept the signal.

As shown in FIG. 2, the first connector 100 may further include a first ID input unit 150, a first storing unit 160 and a first function selecting unit 170.

The first ID input unit 150 receives a preset network ID from a user. The preset network ID may be binary data composed of a plurality of bits. In addition, the first ID input unit 150 may include a switching unit 151 which may set each bit of the plurality of bits.

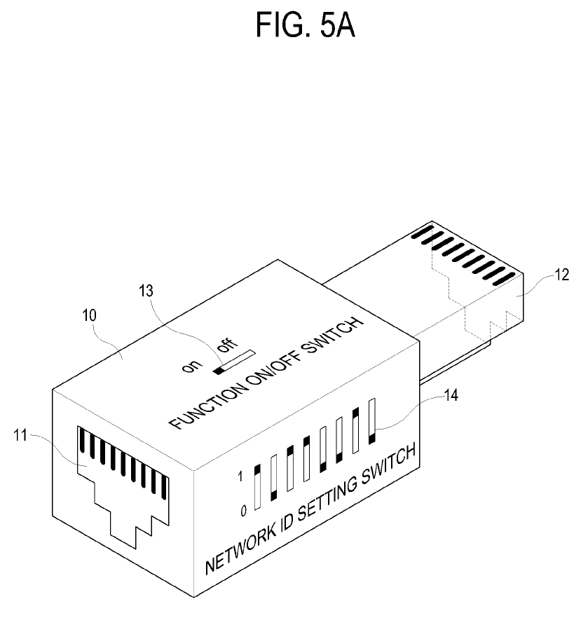

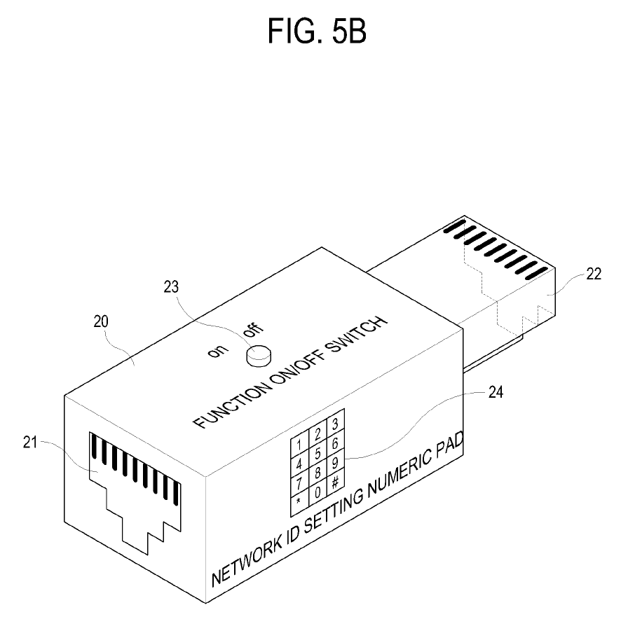

As shown in FIG. 5A, the first connector 100 may be embodied in the form of a dongle 10. The dongle 10 includes a terminal 11 for connection of an RJ-45 plug on one side and a terminal 12 for connection of a LAN card on the other side. In addition, the dongle 10 includes switches 14 for network ID setting. If a network ID has an 8 bit binary data format, the dongle 10 may be provided with 8 switches 14 for setting respective bits.

As an alternative exemplary embodiment, the first ID input unit 150 may be embodied by a numeric pad 24 for network ID setting, as shown in FIG. 5B.

If the network ID of the first network apparatus 300 is a preset network ID, the first controller 140 determines the first network apparatus 300 to be a preset apparatus. Specifically, if the first controller 140 receives a signal including a network ID via the first cable connecting unit 110, the first controller 140 compares the network ID of the received signal with a network ID inputted through the first ID input unit 150 to determine whether or not the network IDs match, and, based on the determination, controls the first communicating unit 130 to deliver only a signal, which is transmitted from an apparatus having the same network ID, to the second network apparatus 400. For example, a signal including the network ID may be a network start signal having a predetermined format. The network start signal is constituted by a plurality of fields, each of which includes information such as an instruction code, an IP address, a protocol, a port, a network ID, a MAC address, cyclic redundancy check (CRC) or the like.

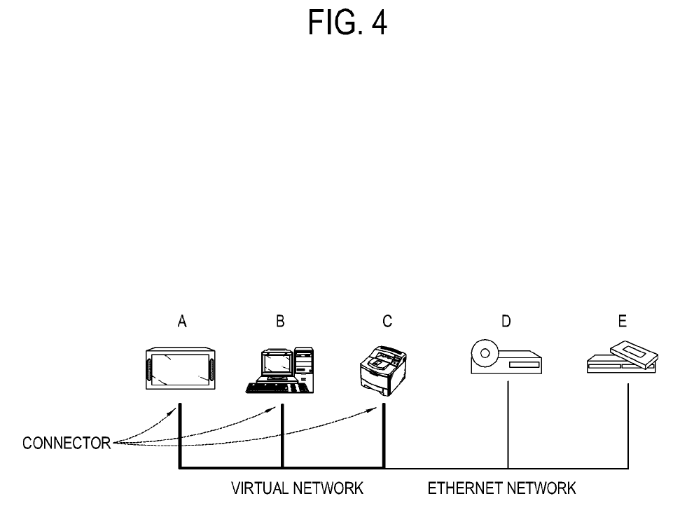

As shown in FIG. 4, a user may connect the connector to network apparatuses A, B and C, for which the user desires to set security, of a plurality of network apparatuses A, B, C, D and E. Then, the user inputs a network ID through the ID input unit of the connector. The network apparatuses A, B and C to which the connector inputted the same network ID is connected can communicate with each other, however, network apparatuses D and E to which the connector is not connected can not access the network apparatuses A, B and C to which the connector is connected. Accordingly, the user has to input the same network ID to the connector connected to the network apparatuses A, B and C for security setting. The network ID is generated and processed in the connector.

A plurality of MAC addresses may be stored in the first storing unit 160 which may be embodied by a nonvolatile memory.

The first controller 140 stores a MAC address of the first network apparatus 300 having the preset network ID in the first storing unit 160. That is, the first controller 140 stores the MAC address of a network apparatus having the same network ID in the first storing unit 160. More specifically, if the first controller 140 receives a signal including a network ID via the first cable connecting unit 110, the first controller 140 compares the network ID included in the received signal with a network ID inputted through the first ID input unit 150 to determine whether or not both network IDs match, and, if it is determined that both network IDs match, stores the MAC address of the first network apparatus 300, which transmits the signal, in the first storing unit 160.

The first controller 140 confirms the MAC address of the first network apparatus 300 for the signal transmitted from the first network apparatus 300 having the preset network ID, and, if the MAC address is a preset MAC address, the first controller 140 determines the first network apparatus 300 to be a preset apparatus. Specifically, if it is determined that the network ID of the first network apparatus 300 is the preset network ID, the first controller 140 stores the MAC address of the first network apparatus 300 in the storing unit 160, and, if the MAC address of the first network apparatus 300 is one of a plurality of MAC addresses stored in the storing unit 160, controls the first communicating unit 130 to deliver the signal, which is received from the first network apparatus 300, to the second network apparatus 400.

The first controller 140 may delete the MAC address of the first network apparatus 300 that transmits the signal based on information of the signal received through the first cable connecting unit 1 10. For example, if the first controller 140 receives a network secession signal having a predetermined format from the first network apparatus 300, the first controller 140 deletes the MAC address of the first network apparatus 300 from the storing unit 160. The network secession signal may be constituted by a plurality of fields, each of which includes information such as an instruction code, an IP address, a protocol, a port, a network ID, a MAC address, cyclic redundancy check (CRC) or the like.

The first controller 140 may control the first communicating unit 130 to deliver the signal to the second network apparatus 400 according to the MAC address of the preset apparatus. For example, the first controller 140 detects and stores a MAC address of an apparatus, which is the destination of the signal, from the signal transmitted from the second network apparatus 400. Thereafter, although the first network apparatus 300 has a first network ID that does not match a second network ID of the second network apparatus 400 or no first network ID, the first network apparatus 300 can communicate with the second network apparatus 400.

The first function selecting unit 170 receives an ON/OFF selection signal from a user. As shown in FIG. 5A, the first function selecting unit 170 may be embodied by an ON/OFF switch 13. As an alternative exemplary embodiment, the first functional selecting unit 170 may be embodied by an ON/OFF button 23, as shown in FIG. 5B.

The first controller 140 may control the first communicating unit 130 to deliver a signal, which is transmitted from a preset apparatus, to the second network apparatus 400 according to an input from the first function selecting unit 170. For example, the first controller 140 generates a network start signal upon receiving an ON signal from the first function selecting unit 170, and generates a network secession signal upon receiving an OFF signal from the first function selecting unit 170. The first controller 140 controls the first communicating unit 130 to deliver the generated network start signal and network secession signal to the second network apparatus 400.

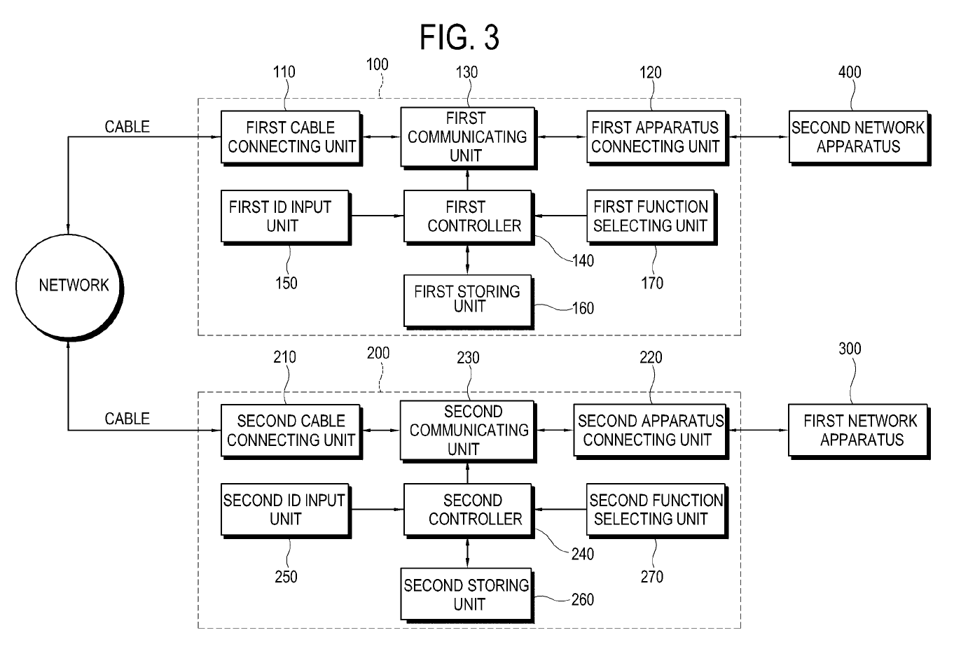

Hereinafter, the second connector 200 according to an exemplary embodiment of the present invention will be described with reference to FIG. 3.

As shown in FIG. 3, the second connector 200 includes a second cable connecting unit 210, a second apparatus connecting unit 220, a second communicating unit 230 and a second controller 240. In addition, the second connector 200 may further include a second ID input unit 250, a second storing unit 260 and a second function selecting unit 270.

The second cable connecting unit 210 is connected to a cable via which a signal is transmitted from and received by the first network apparatus 300.

The second apparatus connecting unit 220 is connected to the first network apparatus 300.

The second communicating unit 230 communicates with the first network apparatus 300 and the second network apparatus 400.

The second controller 240 controls the second communicating unit 230 to deliver a preset network ID to the second network apparatus 400. The second connector 200 connected to the first network apparatus 300 transmits a network start signal for network setting or a network secession signal to the first connector 100 connected to the second network apparatus 400.

The second ID input unit 250 receives the preset network ID from a user. The network ID may be binary data of a plurality of bits. In addition, the second ID input unit 250 may include a switching unit which may set each bit of the plurality of bits.

The second function selecting unit 270 receives an ON/OFF selection signal from a user.

The second controller 240 controls the second communicating unit 230 to deliver the preset network ID to the second network apparatus 400 according to an input from the second function selecting unit 270. For example, if the input from the second function selecting unit 270 is an ON signal, or if the second connector 200 receives an initial signal from the first network apparatus 300, the second connector 200 transmits a network start signal to all apparatuses connected to a network. In addition, if the input from the second function selecting unit 270 is an OFF signal, the second connector 200 transmits a network secession signal to all apparatuses connected to the network. Each of the network start signal and the network secession signal includes a network ID of the second connector 200 and a MAC address of the first network apparatus 300. Upon receiving the network start signal, the first connector 100 determines whether or not a received network ID matches a network ID of the first connector 100, and, if it is determined that the received network ID matches the network ID of the first connector 100, stores the received MAC address. Thereafter, if the MAC address of the received signal matches the pre-stored one, the first connector 100 passes the received signal. Upon receiving the network secession signal, the first connector 100 deletes the MAC address of the received network secession signal from a plurality of pre-stored MAC addresses and intercepts the received signal.

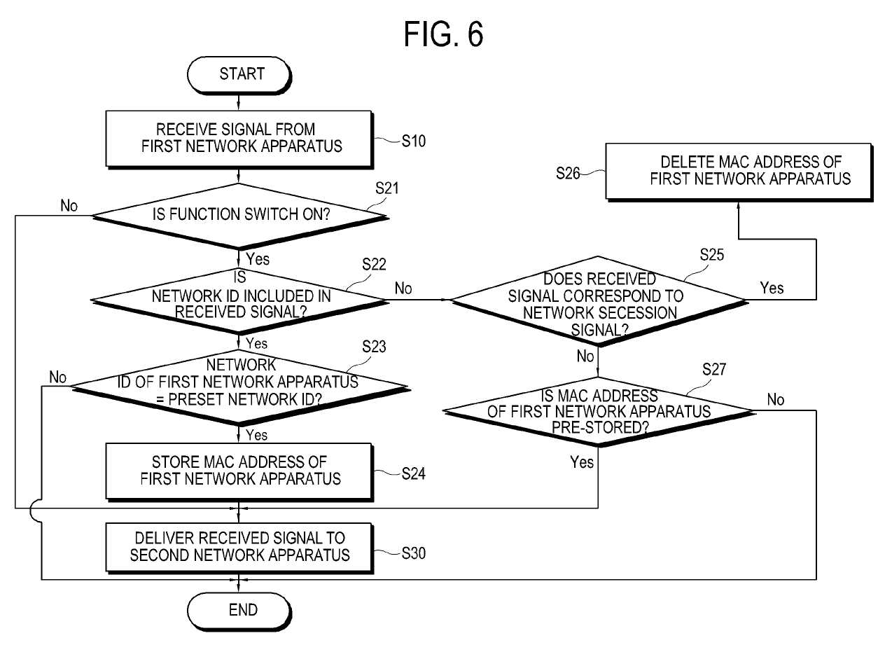

Hereinafter, an operation of the first connector 100 according to an exemplary embodiment of the present invention will be described with reference to FIG. 6.

The first connector 100 receives a signal from the first network apparatus 300 at operation S10. The first connector 100 determines whether or not the first network apparatus 300 that transmits the signal is a preset apparatus at operation S20. If it is determined that the first network apparatus 300 is the preset apparatus, the first connector 100 delivers the signal to the second network apparatus 400 at operation S30.

First, the first connector 100 receives the signal from the first network apparatus 300 via the first cable connecting unit 110 at the operation S10.

Specifically, the operation S20 may include operations S21, S22, S23, S24, S25, S26 and S27. The first controller 140 determines whether or not a function switch of the first function switching unit 170 is in an ON state at operation S21. If it is determined at the operation S21 that the function switch is in the ON state, the first controller 140 determines whether or not a network ID is in the received signal at operation S22. If it is determined at the operation S22 that the network ID is in the received signal, the first controller 140 determines whether the network ID received from the first network apparatus 300 is a preset network ID at operation S23. If it is determined at the operation S23 that the received network ID is the preset network ID, the first controller 140 stores a MAC address of the first network apparatus 300 in the first storing unit 160 at operation S24.

Next, the first controller 140 controls the first communicating unit 130 to deliver the signal, which is received from the first network apparatus 300, to the second network apparatus 400 at operation S30.

If it is determined at the operation S22 that the network ID is not included in the received signal, the first controller 140 determines whether or not the received signal is a network secession signal at operation S25. If it is determined at the operation S25 that the received signal is the network secession signal, the first controller 140 deletes the MAC address of the first network apparatus 300 at operation S26. If it is determined at the operation S25 that the received signal is not the network secession signal, the first controller 140 determines whether or not the MAC address of the first network apparatus 300 is a pre-stored one at operation S27. If it is determined at the operation S27 that the MAC address of the first network apparatus 300 is the pre-stored one, the first controller 140 performs the operation S30. If it is determined at the operation S21 that the function switch is in an OFF state, the first controller 140 performs the operation S30.

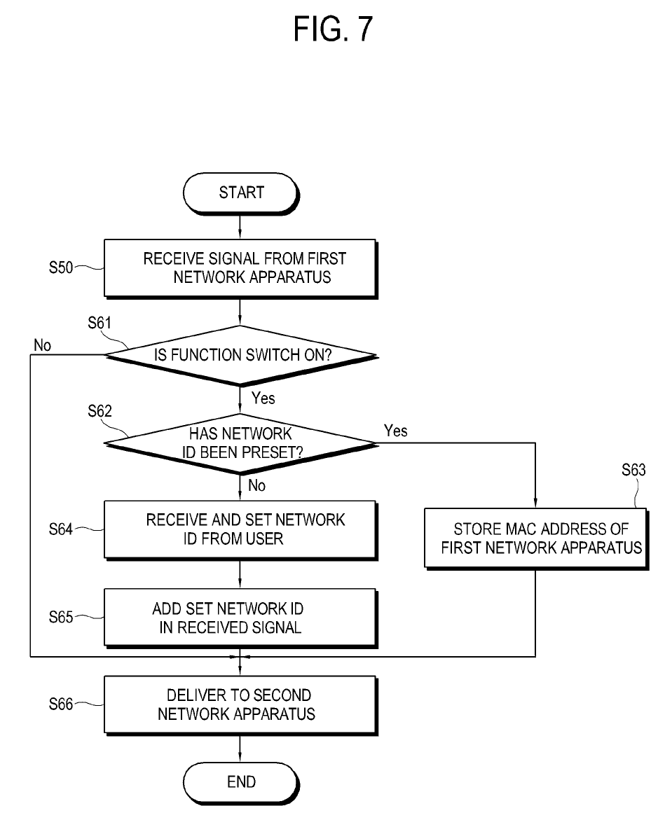

Hereinafter, an operation of the second connector 200 according to another exemplary embodiment of the present invention will be described with reference to FIG. 7.

The second connector 200 receives a signal from the first network apparatus 300 at operation S50. The second connector 200 delivers the signal added a preset network ID to the second network apparatus 400 at operation S60.

First, the second connector 200 receives the signal from the first network apparatus 300 via the apparatus connecting unit 220 at the operation S50.

Specifically, the operation S60 may include operations S61, S62, S63, S64, S65 and S66. The second controller 240 determines whether the function switch of the second function selecting unit 270 is in an ON state at operation S61. If it is determined at the operation S61 that the function switch is in the ON state, the second controller 240 determines whether or not a network ID has been preset at operation S62. If it is determined at the operation S62 that the network ID has been preset, the second controller 240 stores the MAC address of the first network apparatus 300 in the second storing unit 260 at operation S63. If it is determined at the operation S62 that the network ID has not been preset, the second controller 240 receives the network ID from the second ID input unit 250 and stores the received network ID in the second storing unit 260 at operation S64. Next, the stored network ID is included in the received signal at operation S65. Next, the signal is delivered to the second network apparatus 400 at operation S66. If it is determined at the operation S61 that the function switch is in an OFF state, the second controller 240 performs the operation S66.

As is apparent from the above description, the present invention provides a connector and a communication method thereof, which make it possible to form a network of only apparatuses, which are desired by a user, among a plurality of network apparatuses by a method convenient to the user.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A connector comprising:
a cable connecting unit that is connected with a cable via which a signal is transmitted from a first network apparatus;
an apparatus connecting unit that is connected with a second network apparatus;
a communicating unit that communicates with the first network apparatus and the second network apparatus; and
a controller that controls the communicating unit to deliver the signal, which is received from the first network apparatus via the cable connecting unit, to the second network apparatus if the first network apparatus is a preset apparatus.

2. The connector according to claim 1, wherein, if a network ID of the first network apparatus is a preset network ID, the controller determines the first network apparatus to be the preset apparatus.

3. The connector according to claim 2, further comprising an identification (ID) input unit that receives the preset network ID from a user.

4. The connector according to claim 3, wherein the preset network ID is binary data of a plurality of bits.

5. The connector according to claim 4, wherein the ID input unit comprises a switching unit that sets each bit of the plurality of bits.

6. The connector according to claim 2, wherein the controller confirms a media access control (MAC) address of the first network apparatus for the signal transmitted from the first network apparatus having the preset network ID, and, if the MAC address is a preset MAC address, the controller determines the first network apparatus to be the preset apparatus.

7. The connector according to claim 6, further comprising a storing unit in which a plurality of MAC addresses are stored,
wherein the controller stores the MAC address of the first network apparatus having the preset network ID in the storing unit.

8. The connector according to claim 7, wherein the controller deletes the MAC address of the first network apparatus that transmits the signal, based on information of the signal received via the cable connecting unit.

9. The connector according to claim 1, wherein the controller controls the communicating unit to deliver the signal to the second network apparatus based on a media access control (MAC) address of the preset apparatus.

10. The connector according to claim 1, further comprising a function selecting unit that receives an ON/OFF selection signal from a user,
wherein the controller controls the communicating unit to deliver the signal, which is transmitted from the preset apparatus, to the second network apparatus according to the ON/OFF selection signal through the function selecting unit.

11. The connector according to claim 1, wherein the connector has a form of a dongle.

12. A connector comprising:
an apparatus connecting unit that is connected with a first network apparatus;
a cable connecting unit that is connected with a cable via which a signal is transmitted from a second network apparatus;
a communicating unit that communicates with the first network apparatus and the second network apparatus; and
a controller that controls the communicating unit to deliver a preset network ID to the second network apparatus.

13. The connector according to claim 12, further comprising an ID input unit that receives the preset network ID from a user.

14. The connector according to claim 13, wherein the preset network ID is binary data of a plurality of bits.

15. The connector according to claim 14, wherein the ID input unit comprises a switching unit that sets each bit of the plurality of bits.

16. The connector according to claim 12, further comprising a function selecting unit that receives an ON/OFF selection signal from a user,
wherein the controller controls the communicating unit to deliver the preset network ID to the second network apparatus according to the ON/OFF selection signal through the function selecting unit.

17. A communication method of a connector, comprising:
receiving a signal from a first network apparatus;
determining whether the first network apparatus that transmits the signal is a preset apparatus; and
delivering the signal to a second network apparatus if the first network apparatus is the preset apparatus.

18. The communication method according to claim 17, wherein the determining whether the first network apparatus that transmits the signal is a preset apparatus comprises determining the first network apparatus to be the preset apparatus if a network ID of the first network apparatus is a preset network ID.

19. The communication method according to claim 18, further comprising receiving the preset network ID from a user.

20. The communication method according to claim 19, wherein the preset network ID is binary data of a plurality of bits.

21. The communication method according to claim 18, wherein the determining whether the first network apparatus that transmits the signal is a preset apparatus comprises confirming a media access control (MAC) address of the first network apparatus for the signal transmitted from the first network apparatus having the preset network ID and determining the first network apparatus to be the preset apparatus if the MAC address is a preset MAC address.

22. The communication method according to claim 21, further comprising storing the MAC address of the first network apparatus having the preset network ID.

23. The communication method according to claim 22, further comprising deleting the MAC address of the first network apparatus that transmits the signal based on information of the received signal.

24. The communication method according to claim 17, wherein the delivering the signal to the second network apparatus comprises delivering the signal to the second network apparatus based on a media access control (MAC) address of the preset apparatus.

25. A communication method of a connector, comprising:
receiving a signal from a first network apparatus; and
adding a preset network ID in the signal and delivering the signal to a second network apparatus.

26. The communication method according to claim 25, further comprising receiving the preset network ID from a user.

27. The communication method according to claim 26, wherein the preset network ID is binary data of a plurality of bits.
